(19) United States
(12) Patent Application Publication
(10) Pub. No.: US 2024/0031236 A1
(43) Pub. Date: Jan. 25, 2024

(54) CROSS-DOMAIN DISTRIBUTED NETWORK FUNCTION

(71) Applicants: Akhilesh S. Thyagaturu, Ruskin, FL (US); Mohit Kumar Garg, Hisar (IN); Ranganath Sunku, BEAVERTON, OR (US)

(72) Inventors: Akhilesh S. Thyagaturu, Ruskin, FL (US); Mohit Kumar Garg, Hisar (IN); Ranganath Sunku, BEAVERTON, OR (US)

(21) Appl. No.: 18/375,093

(22) Filed: Sep. 29, 2023

(51) Int. Cl. H04L 41/0895; H04L 41/0806; H04L 61/5014

(52) U.S. Cl. CPC H04L 41/0895; H04L 41/0806; H04L 61/5014

(57) ABSTRACT

A cross-domain distributed network function may be constructed by instantiating a local-domain endpoint for a first application component. Here, the local-domain endpoint is in a first network domain that includes the first application component. A connection to an extra-domain endpoint may then be made. Here, the extra domain endpoint is in a second network domain that does not include the first network domain, and the second network domain includes a second application component for the application. The local-domain endpoint may then provide a network service for a third network domain that includes the application. The first application component may then use that network service to connect to the second application component.

### BACKGROUND

Computer networking is a term that relates to the various systems, devices, or protocols that connect computing devices. Computer network is often described in layers, with a physical layer typically defining or describing the physical media (e.g., radio frequency transmission, fiber optic, coper wiring, etc.) and protocols for that media, and an application layer typically defining or describing software that directs communications. A variety of layers, such as a media access layer, may be included between the physical and application layers.

In addressed-based networking, such in Internet Protocol (IP) networks, devices are typically assigned a unique address within an address space, or domain. Typically, to communicate outside of a domain, a gateway is used. Gateways generally bridge domains, with an interface in a first domain (e.g., a local domain) and another interface in a second domain (e.g., remote domain or extra domain). Within a domain, a variety of communication techniques may be used, such as unicast (where there is one destination address for the data), multicast (where there are multiple destinations for the data), or broadcast (where the data is addressed to every address in the domain). Switches are networking devices that direct packets from a sender to a receiver within a domain based on the addressing of the data. Thus, in a unicast transmission, a switch directs the packet directly to an interface of the recipient device. In the case of a broadcast, the switch directs (e.g., copies) the data to every connected device.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of an environment including a system for cross-domain distributed network function, according to an embodiment.

FIG. 2 illustrates an example of unified architecture using a cross-domain switch, according to an embodiment.

FIG. 3 illustrates an example of interactions between client, edge, and cloud components, according to an embodiment.

FIG. 4 illustrates an example of domain interactions, according to an embodiment.

FIGS. 5A-5B illustrates an example of signaling between components, according to an embodiment.

FIG. 6 illustrates a flow diagram of an example of a method for cross-domain distributed network function, according to an embodiment.

FIG. 7 is a block diagram illustrating an example of a machine upon which one or more embodiments may be implemented.

### DETAILED DESCRIPTION

Addressed-based networking has provided reliable inter-computer communication for a long time. While domains ease some administration issues, such as address management (e.g., there generally is no need to coordinate address across the world) including finite address spaces, there are some issues when communicating across domains. Generally, an address in a first domain cannot be used in the second domain. As noted above, a gateway may operate to forward such requests. Network Address Translation (NAT) is a technique by which a gateway may accomplish this task. With NAT, the local request is tracked at the gateway. The gateway replaces the source address with one that the gateway controls in the remote domain and transmits the packet, for example. When a response is received, the original request is located and the original requestor address is written into the response packet as the destination. The response packet may then be sent in the local domain to the original requestor.

Some applications rely on intra-domain communications, such as multicast or broadcast messages. An example of such systems may include augmented reality (AR) or virtual reality (VR), industrial safety (e.g., machine tolerance monitoring, roller coaster safety monitoring, etc.), or other applications that use these intra-domain techniques to, for example, perform resource discovery or management (e.g., device heartbeats). An issue may arise when distributed computing, such as vehicle-edge-cloud architectures are used to deploy such applications. Generally, NAT-less operations to ensure bi-directional connection initiations, the support for discovery or management based on broadcast and multicast traffic domain are difficult. Moreover, using NAT is difficult because, in dynamic environments, a given endpoint device may engage multiple gateways over the course of operation. This leads to complex translation table and packet management across gateways. Further, a virtual private network (VPN) overlay may encounter similar overhead in connection dynamics that is not scalable.

To address the issues noted above, a cross-domain distributed network function may be used. The cross-domain distributed network function is an overlay network with single domain semantics that operates over several domains. The components of the distributed network function include endpoints in the several domains and a backplane that connects these endpoints. The endpoints exist within several domains and operate as network interfaces, much like a typical physical switch. An edge application connects to the endpoint using local hardware semantics and obtains, for example, an IP address and DNS configuration from the overlay network. Thus, the application is able to communicate with other components in the overlay network using local domain semantics even though the components are physical distributed in other network domains.

In an example, the network endpoint is a proxy application that connects to the overlay network functions (e.g., Dynamic Host Configuration Protocol (DHCP), Domain Name System (DNS), etc.) at the application layer of the underlying networks. In an example, where application components are deployed as containers, the proxy may be part of the container, or container adjacent, such as a sidecar. This arrangement reduces most additional management overhead because the proxy applications need merely connect to stable cloud-endpoints to construct the backplane of the distributed network function. By use of the cross-domain distributed network function an application developer may continue to use proven local-domain messaging while also benefiting from distributed cloud-edge architectures. Additional details and examples are provided below.

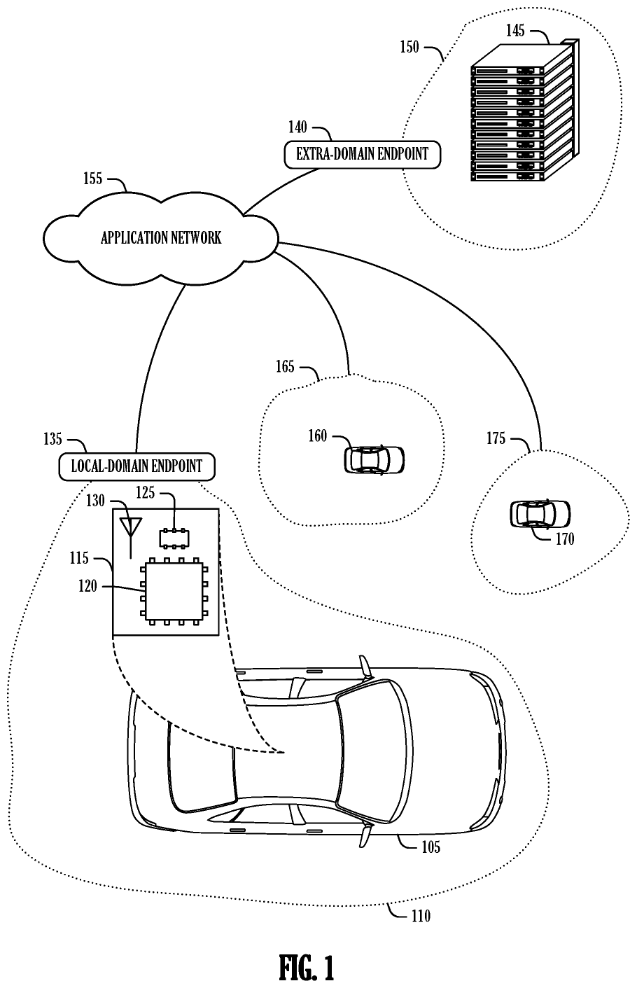

FIG. 1 is an example of an environment including a system for cross-domain distributed network function, according to an embodiment. The illustrated scenario includes an application that spans an edge, the vehicle 105, to a cloud, the server 145. For example, a passenger of the vehicle 105 may be using a VR application to attend a conference while in transit. The vehicle 105 has a local network, or local domain 110, in which the vehicle 105 operates. The local domain 110 is a local network for vehicle components, such as a display terminal, engine diagnostics, etc. The vehicle 105 includes a device 115 that operates in the local domain 110. The device 115 includes processing circuitry 120, a memory 125, and a set of network interfaces, which may include a radio 130 for radio frequency physical layer communications.

Other vehicles, such as the vehicle 160 and the vehicle 170, also have local domains, such as local domain 165 for the vehicle 160 and the local domain 175 for the vehicle 170. Further, the server 145 operates in its own local domain 150. For the various components, the corresponding local domain is the basic networking environment of the component. The application network 155, however, is a network enabled by the cross-domain distributed network function. The application network 155 is a type of overlay network in which the transport mechanisms of the local domains are used but the network semantics are consistent for any component of the application without regard to which local domain that component may be hosted.

The cross-domain distributed network function is enabled by the operation (e.g., local services offered and inter-domain connections) of local endpoints. Because locality may be considered relative, for the discussion below, the local domain 110 is “local” and the local domain 150 is “external.” Accordingly, the endpoint for the local domain 110 is the local-domain endpoint 135 and the endpoint for the local domain 150 is the extra-domain endpoint 140. The structure and operations of the cross-domain distributed network function are described from the perspective of the local-domain endpoint 135, which is implemented by the processing circuitry 120, which may be configured by instructions resident in the memory 125.

The local-domain endpoint 135 functions similarly to a switch port, interfacing with a network device and forming a termination point of a switch backplane. To effectuate this arrangement, the processing circuitry 120 is configured to instantiate (e.g., install, run, execute, start, etc.) the local-domain endpoint 135 for a first application component. Again, the local-domain endpoint 135 is in the local domain 110 (e.g., a first network domain). The local domain 110 also includes the first application component, which is just one part of an application having multiple components. In an example, the local-domain endpoint 135 operates in an application layer of networking. Although there are several network models that have layers, the application layer is the layer furthest from the physical layer, as illustrated in the Open Systems Interconnection (OSI) model. This example illustrates that the local-domain endpoint 135 does not modify the operation of the lower network layers, such as the media access layer. Rather, the local-domain endpoint 135 uses these facilities without modification.

In an example, the application is a virtual reality (VR) or augmented reality (AR) application. In an example, the application is an industrial monitoring or control application. These example applications tend to use multicast or broadcast communications for component discovery, or to solicit responses from components, such as reporting about a current value for a sensor monitoring a machine.

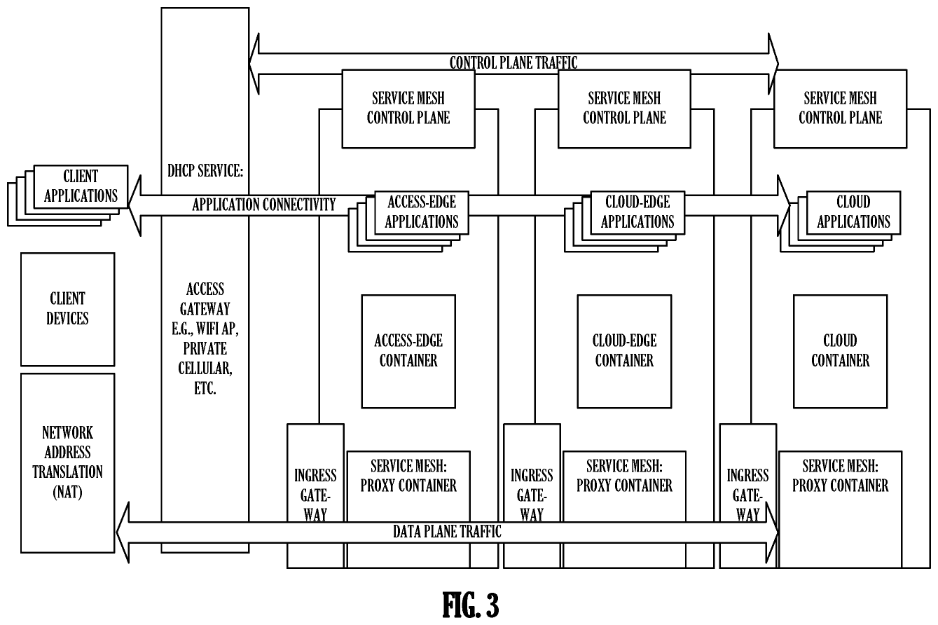

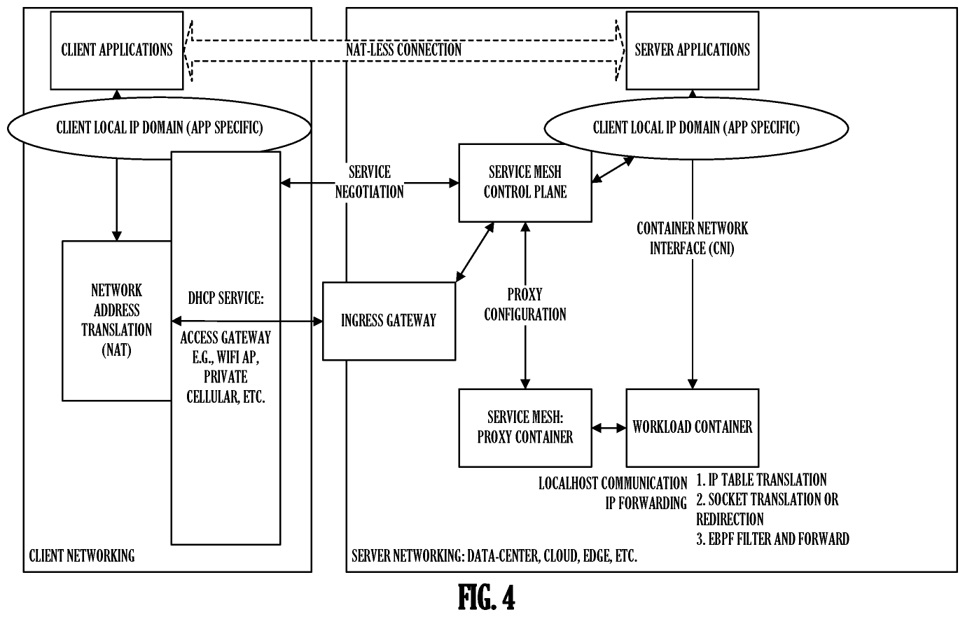

In an example, the first application component is a microservice implemented in a virtual environment, such as a virtual machine. In an example, the first application component is in a container. The environment of the container may be virtual, or may be, in whole or part, implemented by configurable hardware. Containers are often hosted such that multiple containers in a host use (e.g., share) a single operating system (OS) kernel. Some hosting platforms enable encapsulated modifications to containers, called sidecars. A sidecar is deployed with a container to modify some aspect of the container with respect to a particular deployment. In an example, the local-domain endpoint 135 is a container sidecar. In an example, the container is hosted by a multi-access edge computing (MEC) host. In this example, the device 115 is the MEC host. In an example, the extra-domain endpoint 140 is hosted in a cloud. In an example, the local-domain endpoint 135 is a proxy container in a service mesh for the container. FIG. 3 and FIG. 4 illustrate some of these examples.

The processing circuitry 120 is configured to establish a connection to the extra-domain endpoint 140. Again, the extra domain endpoint 140 is in a second network domain (the local domain 150) that does not include the first network domain, the local domain 110. The second network domain also includes a second application component for the application. In an example, where the first application component is a container, establishing the connection to the extra-domain endpoint includes using an ingress gateway of a service mesh control plane hosting the container. FIG. 3 and FIG. 4 illustrate example aspects of this arrangement. Once the connection is established, the bi-directional communications on the connection enables the backplane of the cross-domain distributed function, such as a cross-domain distributed switch, with respect to the two ports represented by the local-domain endpoint 135 and the extra-domain endpoint 140.

The processing circuitry 120 is configured to provide a network service for a third network domain (the application network 155) to the first application component. The third network domain is the network domain of the application. Because the local-domain endpoint 135 operates similarly to a port on a switch, the local-domain endpoint 135 operates to provide the network to the first component of the application. Accordingly, in an example, the network service is one of multiple network services provided by the local-domain endpoint 135. In an example, the multiple network services include DHCP. In an example, the DHCP provides a configuration for the third network domain. In an example, the processing circuitry 120 is configured to receive a DHCP request from the first application component and provide a configuration for the first application component. In an example, the configuration includes an IP address, a default gateway IP address, or a DNS server IP address.

The processing circuitry 120 is configured to pass traffic from the first application component to the second application component via the connection in response to an invocation of the network service by the first application component. This traffic passing completes the switch analogy using the established connection as the backplane to connect the two ports of the local-domain endpoint 135 and the extra-domain endpoint 140. In an example, passing traffic from the first application component to the second application component includes performing a unicast transmission, an any-cast transmission, a multi-cast transmission, or a broadcast transmission. Thus, true local network operations are enabled across a variety of network domains.

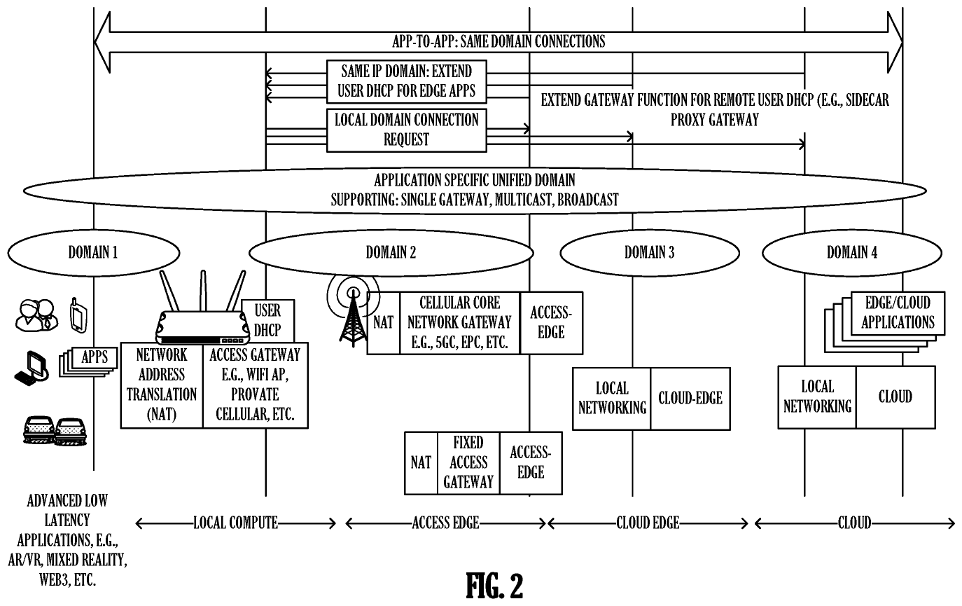

FIG. 2 illustrates an example of unified architecture using a cross-domain switch, according to an embodiment. The components of the architecture are self-explanatory as illustrated. Note is the extension of DHCP for the application specific unified domain across the various domains that span different layers in local-edge-cloud architectures. The application specific unified domain benefits applications that are typically run locally with possible connections to a cloud. For example, applications—such as AR/VR, remote gaming, and web3—typically benefit from user and edge or cloud applications being in the same IP domain to support multicast or broadcast communications. Generally, web3 applications— such as the gaming consoles—and content for AR/VR devices are typically hosted on the local compute, such as in the same local area network (LAN) within a common Wi-Fi access point (AP) gateway. Often, this network architecture cannot be extended to seamlessly offer edge computing services—for example cellular or fixed wireless ISPs—due to multi-level NAT complications that still do not enable broadcast traffic between the application domains. NAT complications may include requiring a client (e.g., local application) to initiate connections (e.g., to the cloud) resulting in techniques such as Transmission Control Protocol (TCP)-keep-alive overhead to be used. These techniques tend to consume network resources including bandwidth and power for little other benefit.

The illustrated architecture uses cloud-native principles, such as the service-mesh-architecture, to readily integrate with client-cloud and edge domains. The architecture is NAT-Less at the local-domain, employing a cross-domain facility derived from a client-first approach. This also results in secondary benefits, such as the power and operational efficiencies. By using a common IP domain, the application specific unified domain, the architecture facilitates new use cases through seamless migration of client-side applications to edge and cloud. Applications such as automotive, robotics, remote controlling (such as closed loop control systems), or other industrial systems that are highly interactive, do not have to change local network paradigms while using flexible and dynamic deployments of application components from local compute to edge compute or cloud compute. Moreover, different application flows may be split into different unified domains. Consider, for each of the illustrated IP domains (e.g., client_app::edge_app::cloud_app), a different flow may be used. Thus, for example, a flow may be specified by the quintuple (e.g., five-tuple): {Source IP, Destination IP, Source Port, Destination Port, and IP type [UDP or TCP] }. Accordingly, each application and each flow may have a separate IP domain. This arrangement may address scalability issues present in some other interconnectivity approaches.

FIG. 3 illustrates an example of interactions between client, edge, and cloud components, according to an embodiment. The illustrated interactions operate within a service-mesh-architecture. From the perspective of client networking, it is typical for the client to initiates the first connection to the server using a DNS look-up for the server. In general, this process creates NAT rules at the NAT table on the client side for the return traffic. In contrast to traditional operations, the application component or workload inside a container is assigned an application domain IP address by the DHCP server of the client side (e.g., from the local domain). If the local domain is a cellular network, then the DHCP server of the cellular network (e.g., the core network) coordinates with the DHCP server of the client-side to be able to receive the IP addresses. In this case, the core network function may be running as a container, coordinated by the service mesh controller, and service mesh proxies.

For the control plane traffic, the client-side DHCP communicates with the service mesh controllers of the edge and cloud and establishes all the networking necessary for the data plane. The data plane traffic passes through the DHCP gateway on the client side to the service mesh proxy container that provides the same domain IPs fetched from the client side, maintaining the same broadcast and multicast domain.

FIG. 4 illustrates an example of domain interactions, according to an embodiment. As illustrated, the service mesh control plane connects to the client DHCP service to establish the proxy configuration for the client-local IP domain. This is then used by the service mesh proxy container (e.g., sidecar) to provide the client-local IP domain configuration of the DHCP service to the workload container. Thus, the server application is operating in the client local IP domain. This client-centric networking also enables client local DNS to the edge or cloud when, for example, a mobile client extends a DNS look-up using the access-edge. This example may facilitate mobility by enabling a component to move to different network domains while maintaining a consistent facility, DNS, for connecting to other components or services.

In an example, the service mesh (e.g., with a sidecar proxy) extends toward the MEC edge in order to ensure communication occurs with the DHCP service at the client side. In an example, this may be implemented in a multi-cluster based universal service mesh that extends the mesh control and management plane at the MEC edge while maintaining a universal management plane at various MEC edges. In an example, in accordance with the ETSI MEC standards, the state management and locality management are coordinated by Edge DNS servers across distributed Edge sites. Service mesh-based sidecar proxies may be extended across these distributed Edge DNS servers to provide NAT facilities without affecting (e.g., modifying) client operations.

For edge or cloud networking, service-mesh benefits—such as privacy, security, networking policies, or traffic splitting at the server—may be enforced while extending the networking from the client. In this way, there emerges a tight coupling of client application with the edge or cloud application. In an example, the ingress gateway may be the DNS resolved address of an application (e.g., someapplication.app.server.com) that sends the request from the client to the service mesh control plane and is be redirected to the proxy inside the service mesh to provide networking to container and the application. This eliminates NAT problems in traditional arrangements, such as nested NATs or double-sided-NATs.

Because service mesh domain controls the proxies used for the common IP domain, the network routing end-to-end follows the traditional routing mechanism, and hence does not need to change. In terms of actual IP addressing to the endpoints they follow normal procedures, and hence do not need any change. For the purpose of actual implementation of the service mesh based common IP domains, IP addressing is derived from the client application domain and applied the edge and cloud domains.

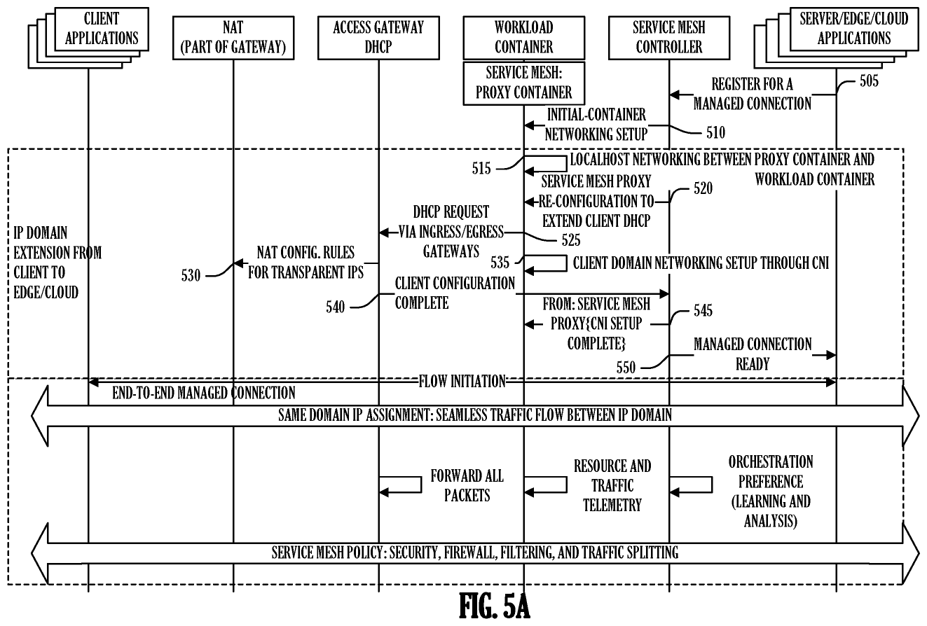

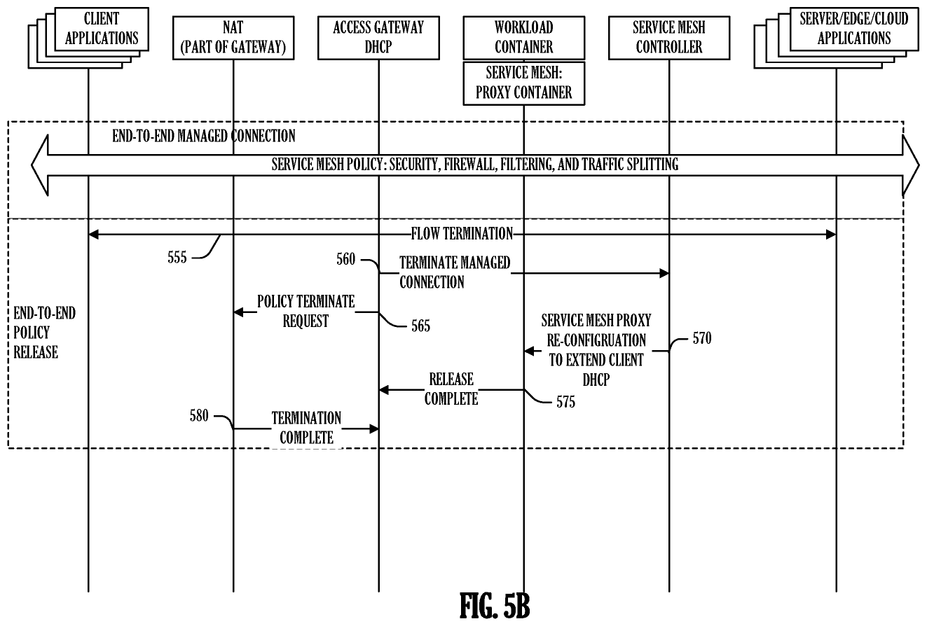

FIGS. 5A-5B illustrate an example of signaling between components, according to an embodiment. When the application component at an edge or cloud server starts, the application component may register with a service mesh controller for a managed connection (operation 505). The service mesh controller requests an initial-container networking setup from the service mesh proxy container (operation 510). The proxy container communicates with the workload container to establish a connection to the access gateway DHCP (operation 515). The service mesh controller then makes a DHCP request (operation 520) to the proxy container, the service request being communicated to the access gateway DHCP (operation 525).

The access gateway DHCP may establish one or more NAT rules in a local table to enable connections between the server and the client (operation 530). The proxy mesh may also complete the IP configuration from the access gateway DHCP response for the workload container (operation 535). Once complete, the access gateway DHCP may signal the service mesh controller that the client configuration is complete (operation 540) that prompts the service mesh controller to signal the proxy container that the network configuration is complete (operation 545). At this point, the proxy container signals the server that the managed connection is ready (operation 550). At this point communications from the server operate in the same IP domain as the application.

When any party initiates a flow termination (operation 555), the access gateway DHCP signals to the service mesh controller that the managed connection is terminated (operation 560). The access gateway DHCP requests that the NAT policy is terminated (operation 565). The service mesh controller requests a DHCP release from the proxy container (operation 570). The proxy container then signals to the access gateway DHCP that the release is complete (operation 575). The NAT facility also signals to the access gateway DHCP that the NAT policy termination is complete, ending the managed connection.

A service mesh is an overlay network that operates at the application layer and is usually managed by a centralized entity contained within a container domain. Because the service mesh operates at the application layers enable use of all underlying network infrastructure of an application as is. Accordingly, there are generally no modifications to the application or the networking layers. The service-mesh proxies that exists as part of container networking are configured to emulate the networking for the application, enable communications as if all components of the application are on a single LAN segment with a single IP domain.

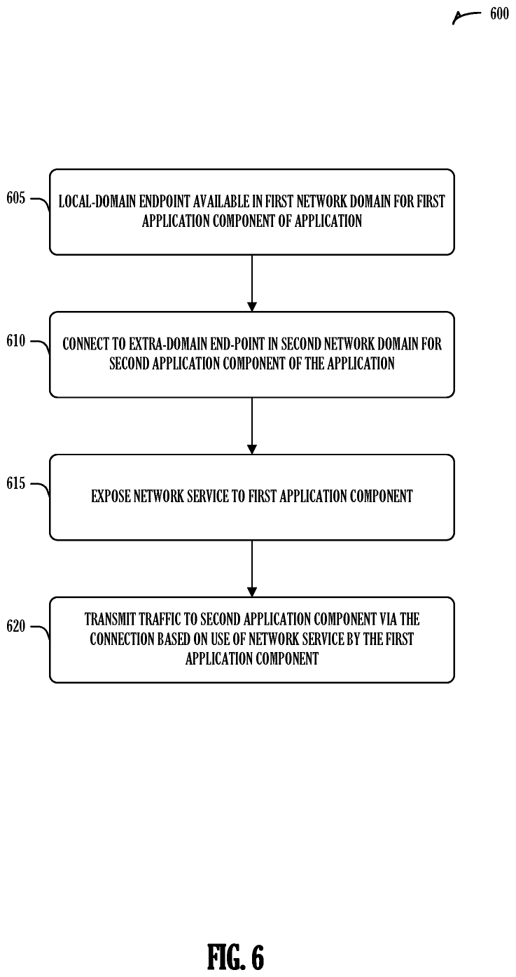

FIG. 6 illustrates a flow diagram of an example of a method 600 for cross-domain distributed network function, according to an embodiment. The method 600 is performed by computational hardware, such as that described above or below (e.g., processing circuitry).

At operation 605, a local-domain endpoint for a first application component is instantiated (e.g., installed, launched, executed, etc.). This local-domain endpoint is in a first network domain that includes the first application component, the first application component being part of an application. In an example, the local-domain endpoint operates in an application layer of networking. In an example, the application is a virtual reality (VR) or augmented reality (AR) application.

In an example, the first application component is in a container. In an example, the container is hosted by a multi-access edge computing (MEC) host. In an example, the extra-domain endpoint is hosted in a cloud. In an example, the local-domain endpoint is a container sidecar. In an example, the local-domain endpoint is a proxy container in a service mesh for the container.

At operation 610, the local-domain endpoint establishes a connection to an extra-domain endpoint. This extra domain endpoint is in a second network domain that does not include the first network domain. The second network also includes a second application component for the application. In an example, where the first application component is a container, establishing the connection to the extra-domain endpoint includes using an ingress gateway of a service mesh control plane hosting the container.

At operation 615, a network service for a third network domain is provided to the first application component. The third network domain includes the application. In other words, the third network domain is the network domain of the application. In an example, the network service is one of multiple network services provided by the local-domain endpoint to the first application component. In an example, the multiple network services include Dynamic Host Configuration Protocol (DHCP). In an example, the DHCP provides a configuration for the third network domain. In an example, the method 600 includes the additional operations of receiving a DHCP request from the first application component and providing a configuration for the first application component. In an example, the configuration includes an Internet Protocol (IP) address, a default gateway IP address, or domain name system (DNS) server IP address.

At operation 620, traffic is passed from the first application component to the second application component via the connection in response to an invocation of the network service by the first application component. In an example, passing traffic from the first application component to the second application component includes performing a unicast transmission, an any-cast transmission, a multi-cast transmission, or a broadcast transmission.

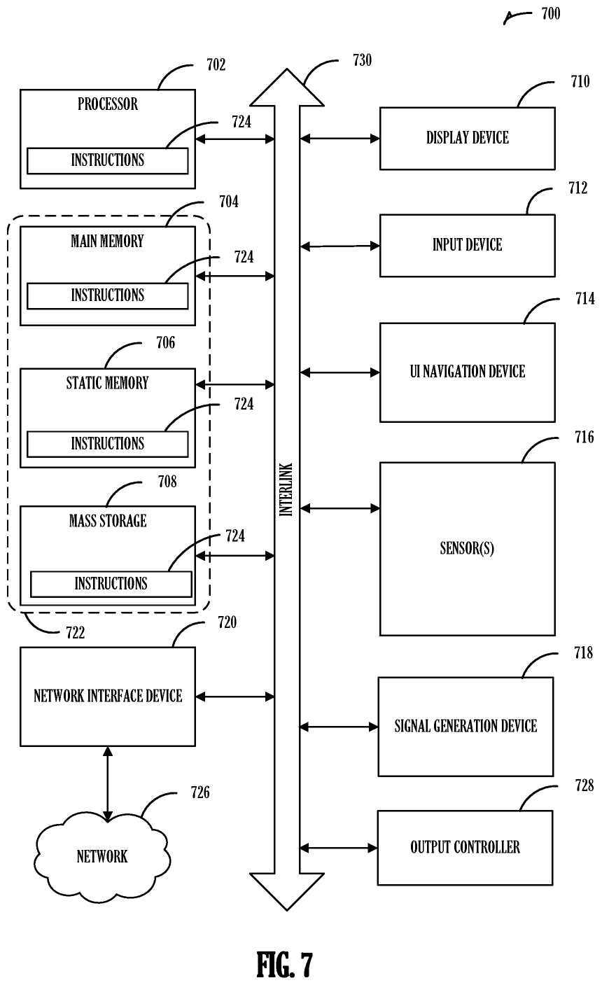

FIG. 7 illustrates a block diagram of an example machine 700 upon which any one or more of the techniques (e.g., methodologies) discussed herein may perform. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc.) 706, and mass storage 708 (e.g., hard drives, tape drives, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 722 may be representative of the instructions 724, such as instructions 724 themselves or a format from which the instructions 724 may be derived. This format from which the instructions 724 may be derived may include source code, encoded instructions (e.g., in compressed or encrypted form), packaged instructions (e.g., split into multiple packages), or the like. The information representative of the instructions 724 in the machine readable medium 722 may be processed by processing circuitry into the instructions to implement any of the operations discussed herein. For example, deriving the instructions 724 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 724.

In an example, the derivation of the instructions 724 may include assembly, compilation, or interpretation of the information (e.g., by the processing circuitry) to create the instructions 724 from some intermediate or preprocessed format provided by the machine readable medium 722. The information, when provided in multiple parts, may be combined, unpacked, and modified to create the instructions 724. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

### Additional Notes & Examples

Example 1 is a device for a cross-domain distributed network function, the device comprising: a memory including instructions; and processing circuitry that is configured by the instructions to: instantiate a local-domain endpoint for a first application component, the local-domain endpoint being in a first network domain that includes the first application component, the first application component being part of an application; establish, by the local-domain endpoint, a connection to an extra-domain endpoint, the extra-domain endpoint being in a second network domain that does not include the first network domain, the second network domain including a second application component for the application; provide, to the first application component, a network service for a third network domain, the third network domain including the application; and pass traffic from the first application component to the second application component via the connection in response to an invocation of the network service by the first application component.
In Example 2, the subject matter of Example 1, wherein the first application component is in a container.
In Example 3, the subject matter of Example 2, wherein the local-domain endpoint is a container sidecar.
In Example 4, the subject matter of any of Examples 2-3, wherein the local-domain endpoint is a proxy container in a service mesh for the container.
In Example 5, the subject matter of any of Examples 2-4, wherein, to establish the connection to the extra-domain endpoint, the instructions configure the processing circuitry to use an ingress gateway of a service mesh control plane hosting the container.
In Example 6, the subject matter of any of Examples 2-5, wherein the container is hosted by a multi-access edge computing (MEC) host, and wherein the extra-domain endpoint is hosted in a cloud.
In Example 7, the subject matter of any of Examples 1-6, wherein the network service is one of multiple network services provided by the local-domain endpoint to the first application component.
In Example 8, the subject matter of Example 7, wherein the multiple network services include Dynamic Host Configuration Protocol (DHCP).
In Example 9, the subject matter of Example 8, wherein the DHCP provides a configuration for the third network domain.
In Example 10, the subject matter of any of Examples 8-9, wherein the instructions configure the processing circuitry to: receive a DHCP request from the first application component; and provide a configuration for the first application component.
In Example 11, the subject matter of any of Examples 9-10, wherein the configuration includes an Internet Protocol (IP) address, a default gateway IP address, or domain name system (DNS) server IP address.
In Example 12, the subject matter of any of Examples 1-11, wherein, to pass traffic from the first application component to the second application component, the instructions configure the processing circuitry to perform a unicast transmission, an any-cast transmission, a multi-cast transmission, or a broadcast transmission.
In Example 13, the subject matter of any of Examples 1-12, wherein the local-domain endpoint operates in an application layer of networking.
In Example 14, the subject matter of any of Examples 1-13, wherein the application is a virtual reality (VR) or augmented reality (AR) application.
In Example 15, the subject matter of any of Examples 1-14, wherein the first application component is a microservice.
In Example 16, the subject matter of any of Examples 1-15, wherein, to establish the connection to the extra-domain endpoint, the processing circuitry does not use or employ a Network Address Translation (NAT) service or protocol.
Example 17 is a method for a cross-domain distributed network function, the method comprising: instantiating a local-domain endpoint for a first application component, the local-domain endpoint being in a first network domain that includes the first application component, the first application component being part of an application; establishing, by the local-domain endpoint, a connection to an extra-domain endpoint, the extra-domain endpoint being in a second network domain that does not include the first network domain, the second network domain including a second application component for the application; providing, to the first application component, a network service for a third network domain, the third network domain including the application; and passing traffic from the first application component to the second application component via the connection in response to an invocation of the network service by the first application component.
In Example 18, the subject matter of Example 17, wherein the first application component is in a container.
In Example 19, the subject matter of Example 18, wherein the local-domain endpoint is a container sidecar.
In Example 20, the subject matter of any of Examples 18-19, wherein the local-domain endpoint is a proxy container in a service mesh for the container.
In Example 21, the subject matter of any of Examples 18-20, wherein establishing the connection to the extra-domain endpoint includes using an ingress gateway of a service mesh control plane hosting the container.
In Example 22, the subject matter of any of Examples 18-21, wherein the container is hosted by a multi-access edge computing (MEC) host, and wherein the extra-domain endpoint is hosted in a cloud.
In Example 23, the subject matter of any of Examples 17-22, wherein the network service is one of multiple network services provided by the local-domain endpoint to the first application component.
In Example 24, the subject matter of Example 23, wherein the multiple network services include Dynamic Host Configuration Protocol (DHCP).
In Example 25, the subject matter of Example 24, wherein the DHCP provides a configuration for the third network domain.
In Example 26, the subject matter of any of Examples 24-25, comprising: receiving a DHCP request from the first application component; and providing a configuration for the first application component.
In Example 27, the subject matter of any of Examples 25-26, wherein the configuration includes an Internet Protocol (IP) address, a default gateway IP address, or domain name system (DNS) server IP address.
In Example 28, the subject matter of any of Examples 17-27, wherein passing traffic from the first application component to the second application component includes performing a unicast transmission, an any-cast transmission, a multi-cast transmission, or a broadcast transmission.
In Example 29, the subject matter of any of Examples 17-28, wherein the local-domain endpoint operates in an application layer of networking.
In Example 30, the subject matter of any of Examples 17-29, wherein the application is a virtual reality (VR) or augmented reality (AR) application.
In Example 31, the subject matter of any of Examples 17-30, wherein the first application component is a microservice.
In Example 32, the subject matter of any of Examples 17-31, wherein establishing the connection to the extra-domain endpoint does not use or employ a Network Address Translation (NAT) service or protocol.
Example 33 is at least one machine readable medium including instructions for a cross-domain distributed network function, the instructions, when executed by processing circuitry of a device, cause the device to perform operations comprising: instantiating a local-domain endpoint for a first application component, the local-domain endpoint being in a first network domain that includes the first application component, the first application component being part of an application; establishing, by the local-domain endpoint, a connection to an extra-domain endpoint, the extra-domain endpoint being in a second network domain that does not include the first network domain, the second network domain including a second application component for the application; providing, to the first application component, a network service for a third network domain, the third network domain including the application; and passing traffic from the first application component to the second application component via the connection in response to an invocation of the network service by the first application component.
In Example 34, the subject matter of Example 33, wherein the first application component is in a container.
In Example 35, the subject matter of Example 34, wherein the local-domain endpoint is a container sidecar.
In Example 36, the subject matter of any of Examples 34-35, wherein the local-domain endpoint is a proxy container in a service mesh for the container.
In Example 37, the subject matter of any of Examples 34-36, wherein establishing the connection to the extra-domain endpoint includes using an ingress gateway of a service mesh control plane hosting the container.
In Example 38, the subject matter of any of Examples 34-37, wherein the container is hosted by a multi-access edge computing (MEC) host, and wherein the extra-domain endpoint is hosted in a cloud.
In Example 39, the subject matter of any of Examples 33-38, wherein the network service is one of multiple network services provided by the local-domain endpoint to the first application component.
In Example 40, the subject matter of Example 39, wherein the multiple network services include Dynamic Host Configuration Protocol (DHCP).
In Example 41, the subject matter of Example 40, wherein the DHCP provides a configuration for the third network domain.
In Example 42, the subject matter of any of Examples 40-41, wherein the operations comprise: receiving a DHCP request from the first application component; and providing a configuration for the first application component.
In Example 43, the subject matter of any of Examples 41-42, wherein the configuration includes an Internet Protocol (IP) address, a default gateway IP address, or domain name system (DNS) server IP address.
In Example 44, the subject matter of any of Examples 33-43, wherein passing traffic from the first application component to the second application component includes performing a unicast transmission, an any-cast transmission, a multi-cast transmission, or a broadcast transmission.
In Example 45, the subject matter of any of Examples 33-44, wherein the local-domain endpoint operates in an application layer of networking.
In Example 46, the subject matter of any of Examples 33-45, wherein the application is a virtual reality (VR) or augmented reality (AR) application.
In Example 47, the subject matter of any of Examples 33-46, wherein the first application component is a microservice.
In Example 48, the subject matter of any of Examples 33-47, wherein establishing the connection to the extra-domain endpoint does not use or employ a Network Address Translation (NAT) service or protocol.
Example 49 is a system for a cross-domain distributed network function, the system comprising: means for instantiating a local-domain endpoint for a first application component, the local-domain endpoint being in a first network domain that includes the first application component, the first application component being part of an application; means for establishing, by the local-domain endpoint, a connection to an extra-domain endpoint, the extra-domain endpoint being in a second network domain that does not include the first network domain, the second network domain including a second application component for the application; means for establishing, by the local-domain endpoint, a connection to an extra-domain endpoint, the extra-domain endpoint being in a second network domain that does not include the first network domain, the second network domain including a second application component for the application; means for providing, to the first application component, a network service for a third network domain, the third network domain including the application; and means for passing traffic from the first application component to the second application component via the connection in response to an invocation of the network service by the first application component.
In Example 50, the subject matter of Example 49, wherein the first application component is in a container.
In Example 51, the subject matter of Example 50, wherein the local-domain endpoint is a container sidecar.
In Example 52, the subject matter of any of Examples 50-51, wherein the local-domain endpoint is a proxy container in a service mesh for the container.
In Example 53, the subject matter of any of Examples 50-52, wherein the means for establishing the connection to the extra-domain endpoint include means for using an ingress gateway of a service mesh control plane hosting the container.
In Example 54, the subject matter of any of Examples 50-53, wherein the container is hosted by a multi-access edge computing (MEC) host, and wherein the extra-domain endpoint is hosted in a cloud.
In Example 55, the subject matter of any of Examples 49-54, wherein the network service is one of multiple network services provided by the local-domain endpoint to the first application component.
In Example 56, the subject matter of Example 55, wherein the multiple network services include Dynamic Host Configuration Protocol (DHCP).
In Example 57, the subject matter of Example 56, wherein the DHCP provides a configuration for the third network domain.
In Example 58, the subject matter of any of Examples 56-57, comprising: means for receiving a DHCP request from the first application component; and means for providing a configuration for the first application component.
In Example 59, the subject matter of any of Examples 57-58, wherein the configuration includes an Internet Protocol (IP) address, a default gateway IP address, or domain name system (DNS) server IP address.
In Example 60, the subject matter of any of Examples 49-59, wherein the means for passing traffic from the first application component to the second application component include means for performing a unicast transmission, an any-cast transmission, a multi-cast transmission, or a broadcast transmission.
In Example 61, the subject matter of any of Examples 49-60, wherein the local-domain endpoint operates in an application layer of networking.
In Example 62, the subject matter of any of Examples 49-61, wherein the application is a virtual reality (VR) or augmented reality (AR) application.
Example 63 is at least one machine-readable medium including instructions that, when executed by processing circuitry, cause the processing circuitry to perform operations to implement of any of Examples 1-62.
Example 64 is an apparatus comprising means to implement of any of Examples 1-62.
Example 65 is a system to implement of any of Examples 1-62.
Example 66 is a method to implement of any of Examples 1-62.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for a cross-domain distributed network function, the device comprising:
a memory including instructions; and
processing circuitry that is configured by the instructions to:
instantiate a local-domain endpoint for a first application component, the local-domain endpoint being in a first network domain that includes the first application component, the first application component being part of an application;
establish, by the local-domain endpoint, a connection to an extra-domain endpoint, the extra-domain endpoint being in a second network domain that does not include the first network domain, the second network domain including a second application component for the application;
provide, to the first application component, a network service for a third network domain, the third network domain including the application; and
pass traffic from the first application component to the second application component via the connection in response to an invocation of the network service by the first application component.

2. The device of claim 1, wherein the network service is one of multiple network services provided by the local-domain endpoint to the first application component.

3. The device of claim 2, wherein the multiple network services include Dynamic Host Configuration Protocol (DHCP).

4. The device of claim 3, wherein the DHCP provides a configuration for the third network domain.

5. The device of claim 3, wherein the instructions configure the processing circuitry to:
receive a DHCP request from the first application component; and
provide a configuration for the first application component.

6. The device of claim 4, wherein the configuration includes an Internet Protocol (IP) address, a default gateway IP address, or domain name system (DNS) server IP address.

7. The device of claim 1, wherein the first application component is a microservice.

8. The device of claim 1, wherein, to establish the connection to the extra-domain endpoint, the processing circuitry does not use or employ a Network Address Translation (NAT) service or protocol.

9. At least one non-transitory machine readable medium including instructions for a cross-domain distributed network function, the instructions, when executed by processing circuitry of a device, cause the device to perform operations comprising:
instantiating a local-domain endpoint for a first application component, the local-domain endpoint being in a first network domain that includes the first application component, the first application component being part of an application;
establishing, by the local-domain endpoint, a connection to an extra-domain endpoint, the extra-domain endpoint being in a second network domain that does not include the first network domain, the second network domain including a second application component for the application;
providing, to the first application component, a network service for a third network domain, the third network domain including the application; and
passing traffic from the first application component to the second application component via the connection in response to an invocation of the network service by the first application component.

10. The at least one non-transitory machine readable medium of claim 9, wherein the first application component is in a container.

11. The at least one non-transitory machine readable medium of claim 10, wherein the local-domain endpoint is a container sidecar.

12. The at least one non-transitory machine readable medium of claim 10, wherein the local-domain endpoint is a proxy container in a service mesh for the container.

13. The at least one non-transitory machine readable medium of claim 10, wherein establishing the connection to the extra-domain endpoint includes using an ingress gateway of a service mesh control plane hosting the container.

14. The at least one non-transitory machine readable medium of claim 10, wherein the container is hosted by a multi-access edge computing (MEC) host, and wherein the extra-domain endpoint is hosted in a cloud.

15. The at least one non-transitory machine readable medium of claim 9, wherein the network service is one of multiple network services provided by the local-domain endpoint to the first application component.

16. The at least one non-transitory machine readable medium of claim 15, wherein the multiple network services include Dynamic Host Configuration Protocol (DHCP).

17. The at least one non-transitory machine readable medium of claim 16, wherein the DHCP provides a configuration for the third network domain.

18. The at least one non-transitory machine readable medium of claim 16, wherein the operations comprise:
receiving a DHCP request from the first application component; and
providing a configuration for the first application component.

19. The at least one non-transitory machine readable medium of claim 17, wherein the configuration includes an Internet Protocol (IP) address, a default gateway IP address, or domain name system (DNS) server IP address.

20. The at least one non-transitory machine readable medium of claim 9, wherein passing traffic from the first application component to the second application component includes performing a unicast transmission, an any-cast transmission, a multi-cast transmission, or a broadcast transmission.

21. The at least one non-transitory machine readable medium of claim 9, wherein the local-domain endpoint operates in an application layer of networking.

22. The at least one non-transitory machine readable medium of claim 9, wherein the application is a virtual reality (VR) or augmented reality (AR) application.

23. The least one non-transitory machine-readable medium of claim 9, wherein the first application component is a microservice.

24. The least one non-transitory machine-readable medium of claim 9, wherein establishing the connection to the extra-domain endpoint does not use or employ a Network Address Translation (NAT) service or protocol.
